(19) United States
(12) Patent Application Publication
(10) Pub. No.: US 2010/0170972 A1
(43) Pub. Date: Jul. 8, 2010

(54) Wet Medium Stirring, Crushing, and Dispersing Machine

(75) Inventor: Akihiro Igarashi, Saitama-pref. (JP)

Correspondence Address: HOFFMANN & BARON, LLP, 6900 JERICHO TURNPIKE, SYOSSET, NY, 11791, US

(73) Assignee: AIMEX. CO., LTD., Tokyo (JP)

(21) Appl. No.: 12/647,984

(22) Filed: Dec. 28, 2009

(30) Foreign Application Priority Data
Jan. 8, 2009 (JP) JP2009-2342
Oct. 2, 2009 (JP) JP2009-230075

(51) Int. Cl. B02C 23/00; B02C 23/10; B02C 17/16

(52) U.S. Cl. 241/38; 241/79; 241/98

(57) ABSTRACT

An aspect of the invention provides a wet medium stirring, crushing, and dispersing machine achieving a high crushing and dispersing effect and high processing efficiency even in a low stirring member stirrer tip speed at which a processed material is not damaged, without particularly increasing the cost. In the wet medium stirring, crushing, and dispersing machine in which beads and slurry are caused to flow to crush and disperse the processed material in the slurry by rotation of a stirring member mounted in a crushing vessel, a small through-hole is made in order to rapidly narrow a flow passage of an in-flow fluent material to generate an orifice contracted flow, and the orifice contracted flow disturbs vectors of the flowing beads to effectively increase a speed difference ΔV between the beads, thereby securing and improving the desired crushing and dispersing effect and the processing efficiency even in the low stirrer tip speed operation.

### BACKGROUND OF THE INVENTION

1. Field of the Invention

The present invention relates to a wet medium stirring, crushing, and dispersing machine. More particularly, the invention relates to a wet medium stirring, crushing, and dispersing machine having secured and further improved high crushing and dispersing effect that a microparticulated processed material is easily obtained with high processing efficiency even operating a stirring member at low stirrer tip speed at which a risk of damaging the processed material is eliminated, without cost increase.

2. Description of the Related Art

The wet medium stirring, crushing, and dispersing machine is widely used in order to finely crush and successfully disperse a raw substance. Examples of the applications of the wet medium stirring, crushing, and dispersing machine include paint, print ink, dye, coating materials, rubber, adhesives, cosmetics, and medicines, of which a product or a partly-finished product are produced by finely crushing and dispersing minerals, pigment, dye, chemicals, magnetic materials, and ceramics.

This type of wet medium stirring, crushing, and dispersing machine includes a cylindrical crushing vessel that is sealed while mounted on a base, a rotary drive shaft that is disposed while inserted in the crushing vessel, a stirring member, such as a disc and a cylindrical rotor, which is rotated while mounted on the rotary drive shaft, and a mechanism, such as a slit, a screen, and a centrifugal separator, which is provided in a discharge portion of the crushing vessel to separate beads and slurry that serve as a medium.

In the wet medium stirring, crushing, and dispersing machine, the crushing vessel is filled with the beads, made of zirconia, silica, glass, or resin, which serve as the crushing and dispersing medium, the slurry including the raw substance that is the processed material and a processing solution is injected in a crushing vessel through an input port of the crushing vessel, the processed material is trapped between the beads by causing the beads and the slurry to flow by rotation of the stirring member, thereby the processed material is crushed or disintegrated to have a desired particle diameter and dispersed, and the slurry that is separated from the beads by the separating mechanism provided in the discharge portion of the crushing vessel is discharged to the outside of the crushing vessel to obtain a product.

There are always three demands for this type of wet medium stirring, crushing, and dispersing machine. The three demands includes crushing of the processed material into desired particle diameter and good dispersion thereof, high processing efficiency of the crushing and dispersion, and suppression or reduction of processing cost. Conventionally, in order to respond to the demands, the stirring member is rotated at a high stirrer tip speed to impart large energy to the beads, and an amount of work of the beads trapping the processed material therebetween is increased to crush the processed material into the desired particle diameter and disperse well the crushed processed materials, in an attempt to improve the processing efficiency.

However, it is found that even if the stirring member is rotated at a high stirrer tip speed to increase the energy imparted to the beads as a result of the attempt, the desired result cannot be obtained because problems that blocks the crushing and dispersing effect or the processing efficiency are generated. Examples of the problems include a decrease in crushing and dispersing efficiency due to the concurrent rotations of the beads and processed material, re-aggregation of the processed material, and abnormal abrasion or abnormal heat generation due to concentration of the beads on the discharge portion of the crushing vessel. Therefore, in order to secure the desired crushing and dispersing effect and the processing efficiency, proposals have been presented that, on the assumption that rotating the stirring member at a high stirrer tip speed is essential, a flow passage of the beads and slurry that flow by the rotation of the stirring member is guided to uniformly distribute the beads in the crushing vessel, and the energy imparted to the beads is effectively utilized by actively moving the beads uniformly in each stirrer tip speed region.

For example, the following flow pas sage guiding means and flow passage guiding members are proposed. Most basic examples are various separating members having a shape or a structure in which the beads separated in the discharge portion is well circulated in the crushing vessel, such as a centrifugal separator, an impeller and a rotary cylinder described in Japanese Patent Application Laid-Open No. 2002-306940. Other examples include openings, such as a long hole made in a stirring disc described in Japanese Patent Application Laid-Open Nos. 2004-8993 and 2005-169340, a separated beads circulating opening in a stirring rotor circumferential wall portion described in Japanese Patent Application Laid-Open No. 2006-7128) that serve as the flow passage guiding means provided in the stirring member, and a flow passage guiding impeller interposed in intermediate positions between a plurality of stirring members mounted on a rotary drive shaft described in Japanese Patent Application Laid-Open No. 2004-8993.

However, recently the demand for the microparticulation of the processed material goes as far as a particle diameter of nanometer range, and the demand for preventing and avoiding the damage of the processed material is strongly raised. Therefore, the proposals presented so far cannot respond to the recent demands. This is because operation at a low stirrer tip speed for the processed material is required in the demand for the microparticulation of the processed material and the demand for preventing and avoiding the damage of the processed material, while the proposals presented so far that propose flow passage guiding means or flow passage guiding members are based on the assumption that imparting large energy to the beads by the high-stirrer-tip-speed operation of the stirring member is essential. That is, in the low-stirrer-tip-speed operation of the stirring member, the centrifugal force is lowered to excessively decrease the energy imparted to the beads, and remarkable degradation of the crushing and dispersing effect cannot be avoided even if the flow passage of the beads can be guided well by the conventional flow passage guiding means or flow passage guiding member.

In order to secure the required crushing and dispersing effect and processing efficiency in the-low-stirrer-tip-speed operation of the stirring member, Japanese Patent Application Laid-Open Nos. 06-142481, 2002-306940, 2004-89993, 2005-169340, and 2006-346667 disclose a technique in which a projection is provided in the stirring member or a baffle is provided in the crushing vessel. The projection or the baffle is proposed and used as means for enhancing the stirring effect on the assumption that the stirring member is operated at the high stirrer tip speed. The reason for which the projection or the baffle is useful to secure the crushing and dispersing effect or the processing efficiency even in the low-stirrer-tip-speed operation is not clear, and the projection or the baffle is used based on experience.

Although the projection or the baffle can contribute to the securement of the crushing and dispersing effect or processing efficiency, the projection or the baffle has a significant problem. Because the heavy abrasion of the projection or baffle inevitably increases running cost of maintenance and replacement, the projection or the baffle does not satisfy the large, universal demand for the cost suppression or reduction. The conventional wet medium stirring, crushing, and dispersing machine which results in the cost increase even though the crushing and dispersing effect and the processing efficiency are improved can be used only in the extremely restricted applications or purposes in which the cost increase is permitted, and marketability of the wet medium stirring, crushing, and dispersing machine is largely restricted.

An object of the invention is to provide a wet medium stirring, crushing, and dispersing machine having secured crushing and dispersing effect that the microparticulated processed material is easily obtained with high processing efficiency even operating at low stirrer tip speed at which the risk of damaging the processed material is eliminated, without increasing the cost. This is because the utilization of the conventional projection or baffle cannot be practiced or is largely narrowed from the viewpoint of the cost although the projection or baffle probably secures the crushing and dispersing effect and processing efficiency, which are required in the low-stirrer-tip-speed operation.

In developing the wet medium stirring, crushing, and dispersing machine, the inventors investigated the reason for which the projection or baffle was useful for the crushing and dispersing effect or processing efficiency in the low-stirrer-tip-speed operation, and the inventors found that the effect of the projection or baffle is attributed to the fact that turbulent flows of the beads or slurry is generated in the crushing vessel.

As schematically illustrated in FIG. 6, a crushing force or a dispersing force of the beads B that trap a processed material R while flowing by the rotation of the stirring member in the crushing vessel is defined not by magnitude of the energy possessed by each of the beads B but by a speed difference ΔV (V2−V1) between the beads B-B that trap the processed material R. When the stirring member is operated at a low stirrer tip speed, although the rotation of the stirring member does not largely impart the energy to each of the beads, the projection or the baffle generates the turbulent flows of the beads or slurry to disturb a vector of each of the beads B, the speed difference ΔV between the beads B-B is increased to enhance the crushing effect of the processed material R, and the disturbance of the vector of each of the processed materials P crushed in the same manner enhances the dispersing effect.

On the contrary, even in the high-stirrer-tip-speed operation in which the large energy is imparted to each of the beads B, unless the speed difference ΔV between the beads B-B that trap the processed material is increased, the energy possessed by each of the beads is not effectively used, and the crushing and dispersing effect or the processing efficiency is decreased due to the concurrent rotation of the beads and processed material, for example.

To address such problems, if the vector of each of the beads or each processed material flowing in the crushing vessel is effectively disturbed by means or method except for the projection or baffle, the wet medium stirring, crushing, and dispersing machine satisfying the requirements of the crushing and dispersing effect and processing efficiency without increasing the cost even in the low-stirrer-tip-speed operation of the stirring member can be implemented to solve the problems.

### SUMMARY OF THE INVENTION

In accordance with a first aspect of the invention, a wet medium stirring, crushing, and dispersing machine includes: a crushing vessel that is mounted on a base and sealed; a rotary drive shaft that is disposed so as to be inserted in the crushing vessel; a stirring member that is mounted on the rotary drive shaft and rotated; and a separating mechanism that is disposed in a discharge portion of the crushing vessel, wherein the stirring member has at least one small through-hole made in an appropriate position of the stirring member, the through-hole rapidly narrowing a flow passage of an in-flow fluent material to generate an orifice contracted flow.

In accordance with a second aspect of the invention, a wet medium stirring, crushing, and dispersing machine includes: a crushing vessel that is mounted on a base and sealed; a rotary drive shaft that is disposed so as to be inserted in the crushing vessel; a stirring member that is mounted on the rotary drive shaft and rotated; and a separating mechanism that is disposed in a discharge portion of the crushing vessel, wherein the stirring member includes a stirring disc, and the stirring disc has at least one small through-hole made in an appropriate position of the stirring disc, the through-hole rapidly narrowing a flow passage of an in-flow fluent material to generate an orifice contracted flow.

In accordance with a third aspect of the invention, a wet medium stirring, crushing, and dispersing machine includes: a crushing vessel that is mounted on a base and sealed; a rotary drive shaft that is disposed so as to be inserted in the crushing vessel; a stirring member that is mounted on the rotary drive shaft and rotated; and a separating mechanism that is disposed in a discharge portion of the crushing vessel, wherein the stirring member includes two stirring discs, the two stirring discs each have at least one small through-hole made in an appropriate position of each of the two stirring discs, the through-hole rapidly narrowing a flow passage of an in-flow fluent material to generate an orifice contracted flow, and the two stirring discs are mounted on the rotary drive shaft while surfaces of the two stirring discs are opposite to each other.

In accordance with a fourth aspect of the invention, in the wet medium stirring, crushing, and dispersing machine according to the first aspect, a flow passage guiding member is mounted on the rotary drive shaft.

As described above, the inventors found that the crushing and dispersing effect and the processing efficiency can be secured at a demanded level to solve the problems even in operation at the low stirring member stirrer tip speed when the vectors of each bead and each processed material, which constitute the fluent material, are disturbed in the crushing vessel, and the inventors focused on the orifice and the orifice contracted flow generated by the orifice.

That is, when the small-diameter orifice that rapidly narrows the flow passage of the fluent material is provided in the crushing vessel in which the beads and slurry flow, the orifice contracted flow is generated immediately before the orifice in the fluent material flowing in the orifice, thereby rapidly and largely changing the force acting on each bead and each processed material, which are of the constituent of the fluent material, and the direction of the force. As a result, a speed difference between the beads trapping the processed materials is increased to improve the crushing effect of the processed material. Similarly the dispersing effect is also improved, because the orifice contracted flow rapidly and largely changes the force of the beads and the processing solution acting on each constituent region of the processed material that is an aggregate and the direction of the force. Thus, the wet medium stirring, crushing, and dispersing machine in which the high crushing and dispersing effect and the high processing efficiency are obtained even in the low stirrer tip speed while the risk of damaging the processed material is eliminated can be implemented by utilizing the orifice and the orifice contracted flow generated by the orifice.

When the crushing and dispersion of the processed material are promoted by utilizing the orifice contracted flow generated by the small-diameter orifice, because the effect of the contracted flow is greater than that of the shear flow, the risk of damaging the processed material flowing in and passing through the orifice is eliminated. Therefore, the wet medium stirring, crushing, and dispersing machine of the invention sufficiently responds to the current demand for preventing and avoiding the damage of the processed material.

Additionally, the small-diameter orifice is easily and rationally provided in the stirring member, and the stirring member is obviously included in the crushing vessel to stir the beads and slurry. Therefore, it is not necessary to newly provide a special orifice member in the crushing vessel. Accordingly, the factor increasing the cost is not generated unlike the conventional technique in which the projection or the baffle is used.

The invention can solve the problem of the wet medium stirring, crushing, and dispersing machine securing the necessary crushing and dispersing effect and processing efficiency at the low stirrer tip speed, without increasing the cost. One of the significant features of the invention is that the small-diameter orifice is provided in the stirring member to solve the problems.

As described above, the invention can provides the wet medium stirring, crushing, and dispersing machine highly securing and improving the crushing and dispersing effect and the processing efficiency even in the low stirrer tip speed at which the risk of damaging the processed material is eliminated, without such cost increase as caused by the utilization of the projection or baffle in the conventional technique.

### BRIEF DESCRIPTION OF DRAWINGS

FIG. 1 is a sectional view illustrating a wet medium stirring, crushing, and dispersing machine according to a first embodiment of the invention;

FIG. 2 is an exploded perspective view illustrating an example of a rotary member that is provided in the wet medium stirring, crushing, and dispersing machine of the first embodiment;

FIG. 3 is a sectional view schematically illustrating an orifice contracted flow that is generated immediately before a small hole made in a stirring member of the wet medium stirring, crushing, and dispersing machine of the first embodiment;

FIG. 4 is a sectional view schematically illustrating a behavior of a fluent material near the small hole made in the stirring member of the wet medium stirring, crushing, and dispersing machine of the first embodiment;

FIG. 5 is a sectional view schematically illustrating a behavior of the fluent material in a crushing vessel of the wet medium stirring, crushing, and dispersing machine of the first embodiment;

FIG. 6 is a front view schematically illustrating action of beads in the crushing vessel of wet medium stirring, crushing, and dispersing machine of the first embodiment;

FIG. 7 is a sectional view illustrating another wet medium stirring, crushing, and dispersing machine according to a second embodiment of the invention; and

FIG. 8 is a sectional view illustrating another wet medium stirring, crushing, and dispersing machine according to a third embodiment of the invention.

### DETAILED DESCRIPTION OF THE INVENTION

### First Embodiment

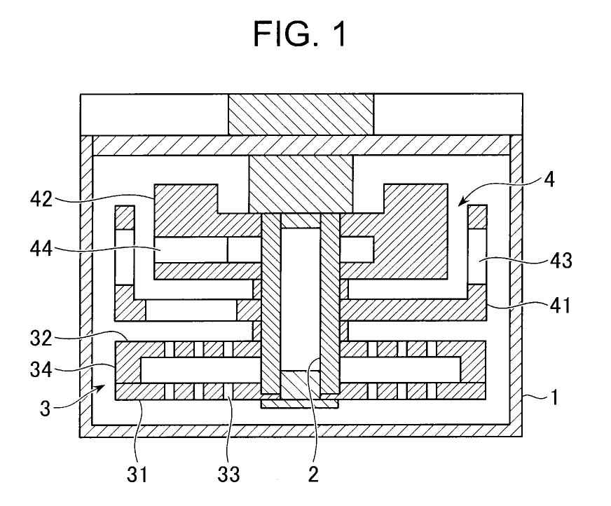

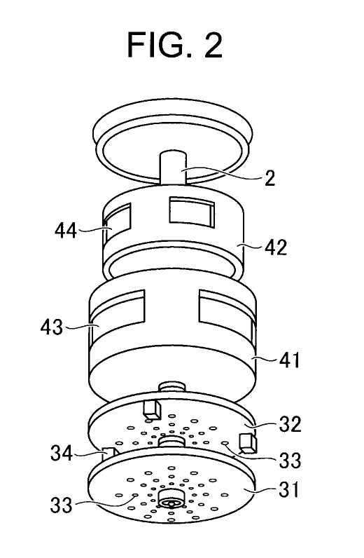

FIG. 1 is a vertical type wet medium stirring, crushing, and dispersing machine according to a first embodiment of the invention, and FIG. 2 illustrates an example of a rotary member that is provided in the wet medium stirring, crushing, and dispersing machine. Similarly to this type of conventional wet medium stirring, crushing, and dispersing machine, the wet medium stirring, crushing, and dispersing machine of the first embodiment includes a cylindrical crushing vessel 1, a rotary drive shaft 2, and two stirring discs 31 and 32. One end side of the crushing vessel 1 is closed while the other end side is opened, and the crushing vessel 1 is mounted on a base (not illustrated) and sealed. The rotary drive shaft 2 is disposed so as to be substantially vertically inserted in the crushing vessel 1. The first and second stirring discs 31 and 32 serve as a stirring member 3 that is mounted on the rotary drive shaft 2 and rotated. The wet medium stirring, crushing, and dispersing machine further includes a centrifugal separator provided in a discharge portion of the crushing vessel 1. However, the wet medium stirring, crushing, and dispersing machine of the first embodiment differs from the conventional wet medium stirring, crushing, and dispersing machine in that a plurality of small holes 33 piercing through the front faces to the rear faces of the first and second stirring discs 31 and 32 are concentrically formed. The stirring discs 31 and 32 are disposed in parallel on the opened end side of the rotary drive shaft 2.

In the second stirring disc 32, an appropriate number of blades 34 are provided in end portion positions of the surface opposite the first stirring disc 31. The stirring discs 31 and 32 are disposed adjacent to each other with a gap in which the blades 34 are interposed being kept constant.

Similarly to this type of wet medium stirring, crushing, and dispersing machine, the centrifugal separator that separates the beads and the slurry to discharge and collect the slurry is mounted on a start end side of the rotary drive shaft 2 that is located in the discharge portion. However, the centrifugal separator of the first embodiment includes large and small rotors 41 and 42. In the rotors 41 and 42, one end side is closed and openings 43 and 44 are provided in circumferential walls. The rotors 41 and 42 are disposed in a nested shape while the opened end sides of the rotors 41 and 42 are located opposite to each other, thereby forming a flow passage guiding member 4.

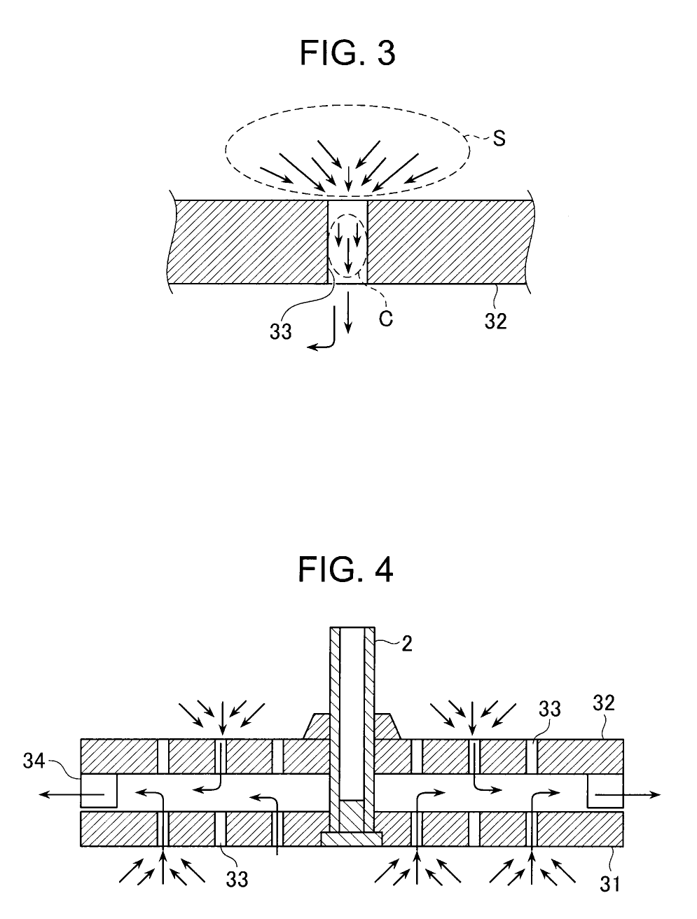

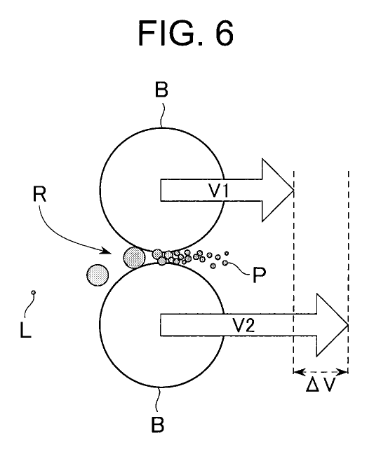

In the wet medium stirring, crushing, and dispersing machine of the first embodiment having the above-described configuration, the small through-holes 33 are made in the surfaces of the first and second stirring discs 31 and 32 that serve as the stirring member 3. The small through-holes 33 act as an orifice that rapidly narrows the flow passage of the fluent material (beads and slurry) in the crushing vessel 1. As already described and illustrated in FIGS. 3 and 6, the crushing vessel 1 is filled with beads, the slurry containing a raw substance that serves as the processed material and a processing solution is injected therein, and the first and second stirring discs 31 and 32 are rotated. As a result, a contracted flow S is generated in a position immediately before the small holes 33 in the beads and slurry that are about to flow into the small holes 33. Because the contracted flow S rapidly and largely changes force acting on each of beads B constituting the fluent material and a direction of the force, a speed difference ΔV between beads B-B trapping the processed material is increased to increase an amount of work of the beads, thereby enhancing crushing of the processed material. Similarly, because the contracted flow S rapidly and largely changes the force in which the beads and processing solution acts on each constituent region P of the processed material R that is of an aggregate and a direction of the force, the dispersion of the crushed processed material P is also largely improved.

As illustrated in FIG. 3, in the wet medium stirring, crushing, and dispersing machine of the first embodiment in which the small holes 33 acting as the orifices are made in the stirring member 3, the contracted flow S is larger than a shear flow C in the small holes 33, and a risk of damaging the processed material passing through the small holes 33 is eliminated. Therefore, the wet medium stirring, crushing, and dispersing machine of the first embodiment can sufficiently respond to the current demand for preventing and avoiding the damage of the processed material.

The small holes 33 can easily be formed in the stirring member, and it is not necessary to attach any particular members like the conventional projection or baffle. Therefore, unlike the case where the heavy abrasion of the projection or baffle requires frequent maintenance or replacement, which increases the cost, the factor that increases the cost is not generated in both the production process and the operation.

There is no particular limitation to the diameter of the small holes that act as the orifice. In consideration of a particle diameter of the bead, an area of the stirring member, and a particle diameter of the desired processed material, the diameter of the small holes may be determined such that the orifice contracted flow is effectively obtained. The small holes 33 having the diameter of 5 mm are formed in the first embodiment. According to the experiment of the inventors, relatively good results were obtained in a range of double to 200 times the particle diameter of the bead, that is, up to the diameter of about 7 mm. The number and positions of small holes are arbitrarily determined because the number and positions of small holes have a mutual dependent relationship with an area of a processing surface of the stirring member. In the first embodiment, in consideration of member strength, 36 small holes 33 are concentrically made in the first and second stirring discs 31 and 32, respectively. According to the experiment of the inventors, relatively good results were obtained when the number of small holes was up to about 30%, preferably 5% to 15%, of the area of the processing surface of the stirring member in terms of an area ratio.

Next, in the first embodiment, the first stirring disc 31 and the second stirring disc 32 are disposed in parallel such that the surfaces of the stirring discs 31 and 32 are located opposite each other. As a result, as illustrated in FIG. 4, the beads and slurry that flow in through the small holes 33 of the stirring discs 31 and 32 are ejected to the opened end side after tentatively retained between the surfaces of the stirring discs 31 and 32 by the centrifugal force, which promotes the flow of the beads and slurry into the small holes 33 and the generation of the good orifice contracted flow immediately before the small holes 33 to enhance the crushing and dispersing effect. The number of stirring members in which the small holes acting as the orifices are provided and the method for providing the stirring member are not limited to those in the first embodiment, but may arbitrarily be selected and set according to the kinds or diameters of the beads and processed material, the desired crushed particle diameter, the application or purpose of the crushing and dispersing process.

At the same time, in the first embodiment, the blades 34 are provided in the end portion positions of the surface of the second stirring disc 32 that is disposed in parallel with the first stirring disc 31, such that the blades 34 are opposite the surface of the first stirring disc 31 and the stirring discs 31 and 32 are disposed adjacent to each other with the gap in which the blades 34 are interposed being kept constant. This is in order that the ejected beads and slurry, which are tentatively retained between the surfaces of the stirring discs 31 and 32 after flowing in through the small holes 33, behave more effectively. Alternatively, for example, an impeller may be used instead of the blades 34; however, any member can be selected and used, and the invention is not limited to such members.

In the wet medium stirring, crushing, and dispersing machine of the first embodiment, the centrifugal separator at the discharge portion that acts as the flow passage guiding member 4 is configured as the rotary body including the large and small rotors 41 and 42 in which one end side is closed while the openings 43 and 44 are provided in the circumferential walls, and the rotors 41 and 42 are disposed in the nested shape while the opened end sides of the rotors 41 and 42 are located opposite each other, thereby producing the unique shape and structure in which the circumferential wall portions including the openings 43 and 44 that communicate the discharge portion separating the beads to outside largely hang over outward. As a result, the smooth flow of the beads separated in the discharge portion toward the outside from the discharge portion is strongly promoted by the rotation of the circumferential wall portion, and the beads circulate well into the crushing vessel 1 through the openings 43 and 44, which facilitates the uniform distribution of the beads in the crushing vessel 1. Conventionally there are attempts and proposals in which a separating member provided in the discharge portion of the wet medium stirring, crushing, and dispersing machine is used as the flow passage guiding member by producing a specific shape or a specific structure to the separating member. However, the shape and structure of the flow passage guiding member 4 (centrifugal separator) of the first embodiment are unique as compared with the conventional examples, and the shape and structure of the flow passage guiding member 4 of the first embodiment have much more excellent effect.

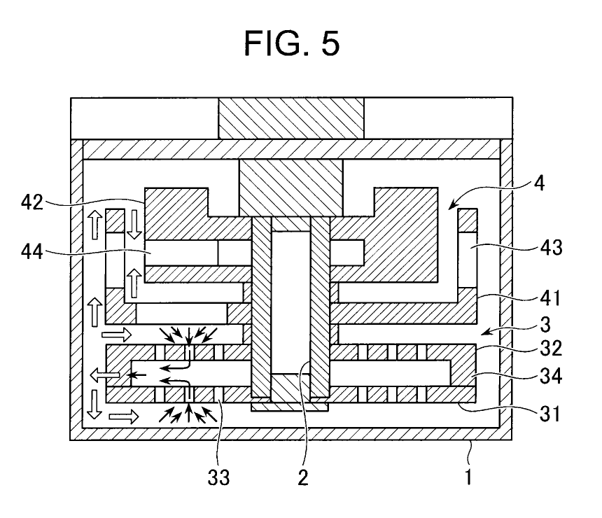

FIG. 5 schematically illustrates behaviors of the beads and slurry in the crushing vessel 1 when the flow passage guiding member 4 of the first embodiment is used. Referring to FIG. 5, the circulations (shown by white arrows) of the beads and slurry, guided from the discharge portion by the flow passage guiding member 4, uniform the distribution of the beads in the crushing vessel 1 and promote the behaviors (shown by black arrows) of the beads and slurry. The beads and slurry flow between the surfaces of the two stirring discs 31 and 32 through the small holes 33, and the beads and slurry are ejected to opened end side after being retained, thereby effectively generating the orifice contracted flow immediately before the small holes 33.

The flow passage guiding member 4 (centrifugal separator) of the first embodiment does not restrict the available separating member or flow passage guiding member in carrying out the invention. Obviously any of various conventional separating members and flow passage guiding members can be selected and used (this means that the invention can widely and easily be applied to the conventional wet medium stirring, crushing, and dispersing machine).

The crushing and dispersing process is performed with the wet medium stirring, crushing, and dispersing machine of the first embodiment described above, and the processing efficiency is compared to that of the conventional machine. Under the condition of a bead filling rate of 60%, it is confirmed that the processing efficiency as high as 94% is improved (comparison to the bead filling rate of 80% in the conventional machine having the same capacity manufactured by the present assignee):

test machine: continuous type beads mill,

particle diameter of beads: 0.7 mm

As described above, the conventional techniques can arbitrarily be selected and used in carrying out the invention. Obviously the projection and the baffle may also be arbitrarily selected and used in carrying out of the invention. That is, in the first embodiment of the invention, independently of the projection or baffle that increases the running cost, the crushing and dispersing effect and processing efficiency that are required in the low-stirrer-tip-speed operation can be secured by utilizing the contracted flow generated by the small holes made in the stirring member. However, the projection or the baffle possibly contributes to the improvement of the crushing and dispersing effect or processing efficiency, and the crushing and dispersing effect or the processing efficiency is neither cancelled nor reduced even if the projection or the baffle is provided in the wet medium stirring, crushing, and dispersing machine of the first embodiment. The running cost increase caused by the projection or baffle can be reduced to obtain a critical point between the effect and the cost by decreasing the number of projections or baffles. Accordingly, the projection or the baffle may freely be used according to the application or purpose of the crushing and dispersing process and are not excluded.

### Second Embodiment

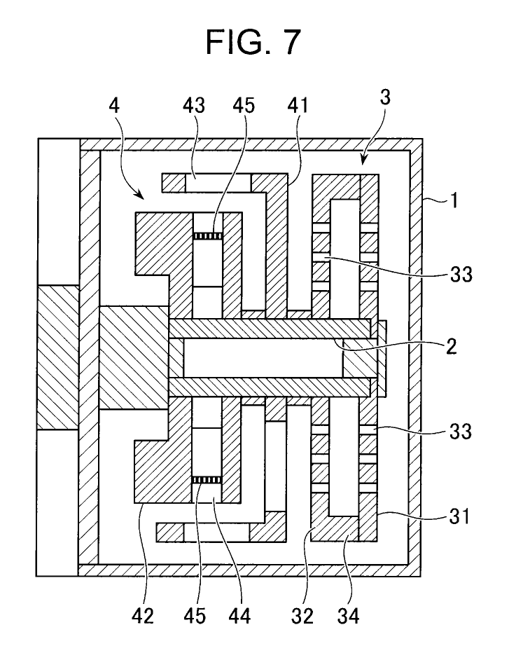

FIG. 7 illustrates a horizontal type wet medium stirring, crushing, and dispersing machine according to a second embodiment of the invention. A basic configuration of the wet medium stirring, crushing, and dispersing machine of the second embodiment is substantially similar to that of the first embodiment. The wet medium stirring, crushing, and dispersing machine of the second embodiment includes the cylindrical crushing vessel 1, the rotary drive shaft 2, and the two stirring discs 31 and 32. One end side of the crushing vessel 1 is closed while the other end side is opened, and the crushing vessel 1 is mounted on a base (not illustrated) and sealed. The rotary drive shaft 2 is disposed so as to be substantially vertically inserted in the crushing vessel 1. The stirring discs 31 and 32 are mounted on the rotary drive shaft 2 and rotated. The wet medium stirring, crushing, and dispersing machine further includes the centrifugal separator that acts as the flow passage guiding member 4 provided in a discharge portion of the crushing vessel 1. The plurality of small holes 33 piercing through the stirring discs 31 and 32 are concentrically formed in surfaces of the stirring discs 31 and 32. As already described above and in the first embodiment, the orifice contracted flow generated immediately before the small holes 33 rapidly and largely changes the force acting on each bead and each processed material and the direction of the force, thereby improving the crushing and dispersing effect of the processed material.

Similarly to the first embodiment, the two stirring discs 31 and 32 mounted on the rotary drive shaft 2 are disposed in parallel such that the surfaces of the stirring discs 31 and 32 are located opposite each other, the blade 34 is provided in the end portion position of the surface of one of the stirring discs, and the surface in which the blade 34 is provided is opposite the surface of the other stirring disc. As a result, the beads and slurry, which flow in through the small holes 33 of the stirring discs 31 and 32, can be ejected to the opened end side after tentatively retained between the surfaces of the stirring discs 31 and 32, thereby facilitating the smooth flow of the beads and slurry into the small holes 33 and the generation of the good orifice contracted flow immediately before the small holes 33 to further enhance the crushing and dispersing effect.

Also in the second embodiment, the flow passage guiding member 4 is mounted in the position of the discharge portion of the rotary drive shaft 2. The flow passage guiding member 4 includes the centrifugal separator in which the large and small hollow rotors 41 and 42 are disposed in the nested shape. In the large and small hollow rotors 41 and 42, one end is opened, and the notch openings are provided in the outer peripheral portions. Thus, the beads separated in the discharge portion are caused to smoothly flow outward and circulate well into the crushing vessel 1 by the rotation of the flow passage guiding member 4 including the opening and has the unique shape and structure in which the circumferential wall portion hangs over outward. Therefore, the beads are easily uniformly distributed in the crushing vessel 1.

In the wet medium stirring, crushing, and dispersing machine of the second embodiment, the unique shape and structure are imparted to the centrifugal separator to act effectively as the flow passage guiding member 4, thereby obtaining the high separating function and circulation function. However, in the horizontal type wet medium stirring, crushing, and dispersing machine in which the beads flow easily in the horizontal direction along the rotary drive shaft 2, when the centrifugal action does not work in the nonoperational centrifugal separator, or when the centrifugal action is weak, the separated beads flow inevitably back to the discharge port. Therefore, in the second embodiment, a screen 45 is provided in the opening portion of the rotor 42 constituting the flow passage guiding member 4 in order to prevent the beads from flowing back to the discharge port.

In order to easily prevent the separated beads from flowing back to the discharge port, the position in which the screen 45 is provided may effectively be selected according to the separating member used as the flow passage guiding member. The invention is not limited to the particular flow passage guiding member 4 of the second embodiment, but various conventional separating members and flow passage guiding members may be arbitrarily selected and appropriately used as mentioned in connect ion with the first embodiment.

### Third Embodiment

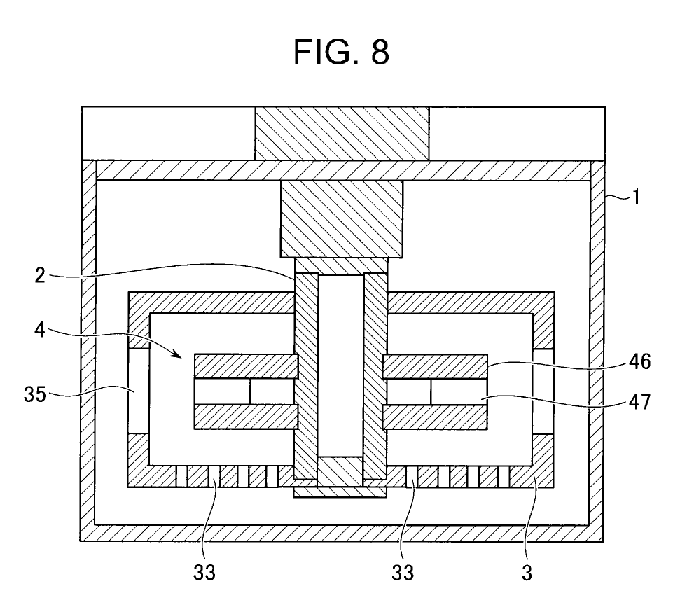

FIG. 8 illustrates a vertical type wet medium stirring, crushing, and dispersing machine according to a third embodiment of the invention. The wet medium stirring, crushing, and dispersing machine of the third embodiment includes the cylindrical crushing vessel 1 and the rotary drive shaft 2. One end side of the crushing vessel 1 is closed while the other end side is opened, and the crushing vessel 1 is mounted on a base (not illustrated) and sealed. The rotary drive shaft 2 is disposed so as to be substantially vertically inserted in the crushing vessel 1. The wet medium stirring, crushing, and dispersing machine further includes a centrifugal separator mounted in an opening position of a discharge port (not illustrated) provided in the rotary drive shaft 2, thereby forming the flow passage guiding member 4. The centrifugal separator includes a hollow rotor 46 that has an opening 47 in an outer peripheral surface of the hollow rotor 46. The stirring member 3 of the third embodiment includes a cylindrical hollow rotating body in which the outer peripheral surface and the upper and lower end faces are closed. In the position in which the flow passage guiding member 4 is mounted on the rotary drive shaft 2, the stirring member 3 is mounted such that the flow passage guiding member 4 is accommodated in the hollow portion of the stirring member 3. The plurality of small through-holes 33 are concentrically made in the closed lower end face of the stirring member 3, and a circulating opening 35 is provided in the outer peripheral surface of the stirring member 3.

In the vertical type wet medium stirring, crushing, and dispersing machine of the third embodiment having the above-described structure, the crushing vessel 1 is filled with the beads, the slurry including the processed material and the processing solution is injected and the stirring member 3 is rotated. As a result, the beads and slurry flow into the hollow portion of the stirring member 3 through the small holes 33 provided in the lower end face of the stirring member 3. After the crushing and dispersing process, the flow passage guiding member 4 separates the beads and the slurry from each other in the discharge portion, the separated beads circulate through the opening 35 of the stirring member 3 into the crushing vessel 1 outside the hollow portion, and the beads and the slurry in the crushing vessel 1 flow repeatedly in the hollow portion of the stirring member 3.

At this point, the force acting on each bead and each processed material particle, which flow in the small holes 33, and the direction of the force are rapidly and largely changed by the orifice contracted flow that is generated immediately before the small holes 33 made in the lower end face of the stirring member 3. Therefore, as already described in connection with the first and second embodiments, the required crushing effect and dispersing effect of the processed material can be secured without increasing the cost even in the low-stirrer-tip-speed operation, the flow passage guiding member 4 mounted in the discharge portion facilitates the smooth circulation flow and uniform distribution of the separated beads to enhance the efficiency of the whole crushing and dispersing process. Additionally, the following effective point can be cited from the viewpoints of the improvements of the crushing and dispersing effect and processing efficiency.

In the third embodiment, the stirring member 3 that is the hollow cylindrical rotating body is provided while the centrifugal separator that is the flow passage guiding member 4 of the separating means is accommodated in the hollow portion of the stirring member 3. Therefore, as compared with the conventional wet medium stirring, crushing, and dispersing machine, it is apparent that the structure is simple and the miniaturization is easy to achieve, and great convenience is offered in both the production stage and the operating stage.

In the wet medium stirring, crushing, and dispersing machine of the first embodiment and this type of conventional wet medium stirring, crushing, and dispersing machine, the stirring member and the separating member (flow passage guiding member) are mounted in different positions of the rotary drive shaft, and the dispersing region and the separating region are individually formed while occupying different portions in the crushing vessel. On the other hand, in the third embodiment, the dispersing region and the separating region are formed in the common space of the hollow portion of the stirring member 3. This means that the beads and slurry flowing in the hollow portion of the stirring member can flow freely and easily be guided in the commonly-located dispersing region and separating region. Therefore, the dispersion of the beads or processed material in the dispersing region, the separation of the beads and processed material in the separating region, and the circulation to the dispersing region and uniform distribution of the separated beads are realized more smoothly and easily.

As is clear from FIG. 8, in the wet medium stirring, crushing, and dispersing machine of the third embodiment, the stirring member 3 and the flow passage guiding member 4 of a separating member have structures symmetrical to each other in the commonly-located dispersing region and separating region, and the uniform energy is applied to the beads or the processed material. Therefore, the uniform dispersion is obtained by the uniform energy field, and the crushing and dispersing effect and the processing efficiency can further be improved.

In the stirring member of the invention, it is necessary to make the small hole that generates the orifice contracted flow. In addition to the stirring member, the small hole may be made in a member except for the stirring member. This is because, for example, in the wet medium stirring, crushing, and dispersing machine of the third embodiment in which the dispersing region and the separating region are formed in the common space while the centrifugal separator that is the flow pas sage guiding member is accommodated in the hollow portion of the stirring member, because a merger portion is formed between the member that exerts the dispersing function and the member that exerts the separating function, clearly the dispersion is improved when the small hole is made in the merger portion. Further, in the wet medium stirring, crushing, and dispersing machine of the second embodiment in which the beads and slurry flow easily in the horizontal direction along the rotary drive shaft, the small hole made in the rotary portion of the separating member that is the flow passage guiding member exerts the dispersing function by the orifice contracted flow. The unique effect of the invention, obtained by the small hole made in the stirring member, is not lost or degraded even if the small hole is made in the member except for the stirring member.

What is claimed is:

1. A wet medium stirring, crushing, and dispersing machine comprising:
a crushing vessel that is mounted on a base and sealed;
a rotary drive shaft that is disposed so as to be inserted in the crushing vessel;
a stirring member that is mounted on the rotary drive shaft and rotated; and
a separating mechanism that is disposed in a discharge portion of the crushing vessel, wherein
the stirring member has at least one small through-hole made in an appropriate position of the stirring member, the through-hole rapidly narrowing a flow passage of an in-flow fluent material to generate an orifice contracted flow.

2. A wet medium stirring, crushing, and dispersing machine comprising:
a crushing vessel that is mounted on a base and sealed;
a rotary drive shaft that is disposed so as to be inserted in the crushing vessel;
a stirring member that is mounted on the rotary drive shaft and rotated; and
a separating mechanism that is disposed in a discharge portion of the crushing vessel, wherein
the stirring member includes a stirring disc, and
the stirring disc has at least one small through-hole made in an appropriate position of the stirring disc, the through-hole rapidly narrowing a flow passage of an in-flow fluent material to generate an orifice contracted flow.

3. A wet medium stirring, crushing, and dispersing machine comprising:
a crushing vessel that is mounted on a base and sealed;
a rotary drive shaft that is disposed so as to be inserted in the crushing vessel;
a stirring member that is mounted on the rotary drive shaft and rotated; and
a separating mechanism that is disposed in a discharge portion of the crushing vessel, wherein
the stirring member includes two stirring discs,
the two stirring discs each have at least one small through-hole made in an appropriate position of each of the two stirring discs, the through-hole rapidly narrowing a flow passage of an in-flow fluent material to generate an orifice contracted flow, and
the two stirring discs are mounted on the rotary drive shaft while surfaces of the two stirring discs are opposite to each other.

4. The wet medium stirring, crushing, and dispersing machine according to claim 1, wherein a flow passage guiding member is mounted on the rotary drive shaft.
